(19) United States
(12) Patent Application Publication
(10) Pub. No.: US 2017/0249155 A1
(43) Pub. Date: Aug. 31, 2017

(54) Memory System and Method for Fast Firmware Download

(71) Applicant: SanDisk Technologies Inc., Plano, TX (US)

(72) Inventors: Kapil Sundrani, Bangalore (IN); Jameer Babasaheb Mulani, Sangli (IN); Bobby Ray Southerland, Longmont, CO (US)

(73) Assignee: SanDisk Technologies Inc., Plano, TX (US)

(21) Appl. No.: 15/055,166

(22) Filed: Feb. 26, 2016

(51) Int. Cl. G06F 9/44; G06F 1/28; H04L 29/08

(52) U.S. Cl. CPC G06F 9/4401; H04L 67/06; G06F 1/28

(57) ABSTRACT

A memory system and method for fast firmware download are provided. In one embodiment, a memory system is presented comprising non-volatile memory, volatile memory, and a controller. The controller is configured to receive a boot loader and firmware; store the boot loader and firmware in the volatile memory; execute the boot loader, wherein executing the boot loader causes the controller to read the firmware from the volatile memory, decompress the firmware, and store the decompressed firmware in the volatile memory; and copy the compressed firmware from the volatile memory to the non-volatile memory. Other embodiments are provided.

### BACKGROUND

Memory systems, such as those that are embedded in devices like solid-state drives (SSDs) and mobile phones, typically contain a controller and a non-volatile memory that stores firmware for the device. The firmware can be stored in the device during manufacturing, and new firmware can be downloaded to the device when later updates are made available. FIG. 8 is a block diagram that illustrates a prior art embedded memory system with an ongoing firmware download. In this example, the embedded memory system has a controller (here, a system-on-chip (SOC) with integrated volatile memory (iRAM)), another volatile memory that is external to the SOC (“external DRAM”), and a non-volatile memory (NOR Flash). The embedded memory system is in communication with a download server via an external interface. In operation, a firmware image is downloaded from the download server to the embedded system in a plurality of portions, and each of those portions is stored in the DRAM, which acts as a buffer. The existing firmware in the NOR Flash is erased, and the portions of the downloaded firmware are moved from the DRAM to the NOR Flash. The process of erasing the old firmware and writing the new firmware into NOR Flash can take a relatively-long time, during which time the memory system may not be able to process other requests or may operate in a reduced performance mode.

### BRIEF DESCRIPTION OF THE DRAWINGS

FIG. 1A is a block diagram of a non-volatile memory system of an embodiment.

FIG. 1B is a block diagram illustrating an exemplary storage module of an embodiment.

FIG. 1C is a block diagram illustrating a hierarchical storage system of an embodiment.

FIG. 2A is a block diagram illustrating exemplary components of the controller of the non-volatile memory system illustrated in FIG. 1A according to an embodiment.

FIG. 2B is a block diagram illustrating exemplary components of the non-volatile memory storage system illustrated in FIG. 1A according to an embodiment.

FIG. 3 is a diagram illustrating a memory system of an embodiment.

FIG. 4 is a diagram illustrating activation of a new boot loader of an embodiment.

FIG. 5 is a diagram illustrating a boot loader of an embodiment activating new firmware.

FIG. 6 are graphs of an embodiment showing download time by drive capacity.

FIG. 7 is a flow chart of a method of an embodiment for fast firmware download.

FIG. 8 is an illustration of a prior art memory system.

### DETAILED DESCRIPTION

Overview

By way of introduction, the below embodiments relate to a memory system and method for fast firmware download. In one embodiment, a memory system is presented comprising non-volatile memory, volatile memory, and a controller in communication with the non-volatile memory and the volatile memory. The controller is configured to receive a boot loader and firmware; store the boot loader and firmware in the volatile memory; execute the boot loader, wherein executing the boot loader causes the controller to read the firmware from the volatile memory, decompress the firmware, and store the decompressed firmware in the volatile memory; and copy the compressed firmware from the volatile memory to the non-volatile memory.

In some embodiments, the controller is further configured to copy the compressed firmware from the volatile memory to the non-volatile memory as a background process.

In some embodiments, the controller is further configured to validate the decompressed firmware before copying the compressed image from the volatile memory to the non-volatile memory.

In some embodiments, the controller is further configured to reset the memory system to activate the firmware.

In some embodiments, the controller is further configured to keep the volatile memory in an auto-refresh mode during the reset to activate the firmware.

In some embodiments, the memory system further comprises a power fail backup system in communication with the controller and a second non-volatile memory in communication with the power fail backup system. In these embodiments, the controller is further configured to register, in the power fail backup system, an identification of a location in the volatile memory of the compressed firmware after storing the decompressed firmware in the volatile memory but before copying the firmware to the non-volatile memory. In these embodiments, the power fail backup system is configured to copy the compressed firmware from the volatile memory to the second non-volatile memory in response to a power loss to the memory system; and copy the firmware from the second non-volatile memory to the volatile memory after power is returned.

In some embodiments, the second non-volatile memory is configured to be written to faster than the non-volatile memory.

In some embodiments, the controller is further configured to unregister, in the power fail backup system, the identification of the location in the volatile memory of the compressed firmware after the firmware is copied from the volatile memory to the non-volatile memory.

In some embodiments, the compressed firmware is an update to a prior version of the firmware stored in the memory system, and wherein the controller is further configured to invalidate the prior version after the compressed firmware is copied from the volatile memory to the non-volatile memory.

In some embodiments, the controller is part of a system-on-chip. The system-on-chip can comprises its own volatile memory, and the controller can further be configured to copy the boot loader from the volatile memory to the system-on-chip's volatile memory before executing the boot loader.

In some embodiments, the non-volatile memory comprises a three-dimensional memory array.

In some embodiments, the memory system is embedded in a host. In another embodiment, the memory system is removably connectable to a host.

In another embodiment, a method for fast firmware download is provided and performed in a memory system comprising non-volatile memory and volatile memory. This method comprises receiving new firmware; storing the new firmware in the volatile memory; and activating the new firmware before storing it in the non-volatile memory.

In some embodiments, activating the new firmware comprises decompressing the new firmware.

In some embodiments, the new firmware is stored in the non-volatile memory as a background process.

In some embodiments, the method further comprises validating the new firmware before storing it in the non-volatile memory.

In some embodiments, the method further comprises registering the new firmware in a power fail backup system prior to storing the new firmware in the non-volatile memory.

In some embodiments, the non-volatile memory comprises a three-dimensional memory array.

In some embodiments, the memory system is embedded in a host.

In another embodiment, a memory system is provided comprising non-volatile memory; volatile memory; and a fast firmware downloader in communication with the non-volatile memory and the volatile memory, wherein the fast firmware downloader is configured to activate new firmware stored in the volatile memory before storing the new firmware in the non-volatile memory.

In some embodiments, the non-volatile memory comprises a three-dimensional memory array.

In some embodiments, the memory system is embedded in a host.

Other embodiments are possible, and each of the embodiments can be used alone or together in combination. Accordingly, various embodiments will now be described with reference to the attached drawings.

### Exemplary Embodiments

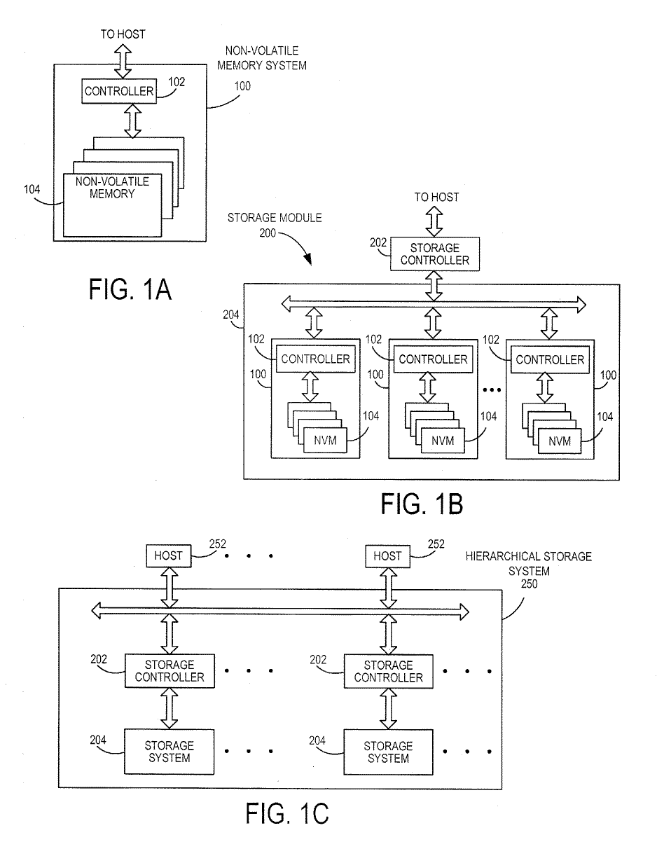

Memory systems suitable for use in implementing aspects of these embodiments are shown in FIGS. 1A-1C. FIG. 1A is a block diagram illustrating a non-volatile memory system 100 according to an embodiment of the subject matter described herein. Referring to FIG. 1A, non-volatile memory system 100 includes a controller 102 and non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a flash memory controller) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host needs to read data from or write data to the flash memory, it will communicate with the flash memory controller. If the host provides a logical address to which data is to be read/written, the flash memory controller can convert the logical address received from the host to a physical address in the flash memory. (Alternatively, the host can provide the physical address.) The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, memory system 100 may be a card based system, such as a secure digital (SD) or a micro secure digital (micro-SD) card. In an alternate embodiment, memory system 100 may be part of an embedded memory system.

Although, in the example illustrated in FIG. 1A, non-volatile memory system 100 (sometimes referred to herein as a storage module) includes a single channel between controller 102 and non-volatile memory die 104, the subject matter described herein is not limited to having a single memory channel. For example, in some NAND memory system architectures (such as the ones shown in FIGS. 1B and 1C), 2, 4, 8 or more NAND channels may exist between the controller and the NAND memory device, depending on controller capabilities. In any of the embodiments described herein, more than a single channel may exist between the controller and the memory die, even if a single channel is shown in the drawings.

FIG. 1B illustrates a storage module 200 that includes plural non-volatile memory systems 100. As such, storage module 200 may include a storage controller 202 that interfaces with a host and with storage system 204, which includes a plurality of non-volatile memory systems 100. The interface between storage controller 202 and non-volatile memory systems 100 may be a bus interface, such as a serial advanced technology attachment (SATA) or peripheral component interface express (PCIe) interface. Storage module 200, in one embodiment, may be a solid state drive (SSD), such as found in portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system via a bus interface. In one embodiment, the bus interface may be an NVMe or fiber channel over Ethernet (FCoE) interface. In one embodiment, the system illustrated in FIG. 1C may be a rack mountable mass storage system that is accessible by multiple host computers, such as would be found in a data center or other location where mass storage is needed.

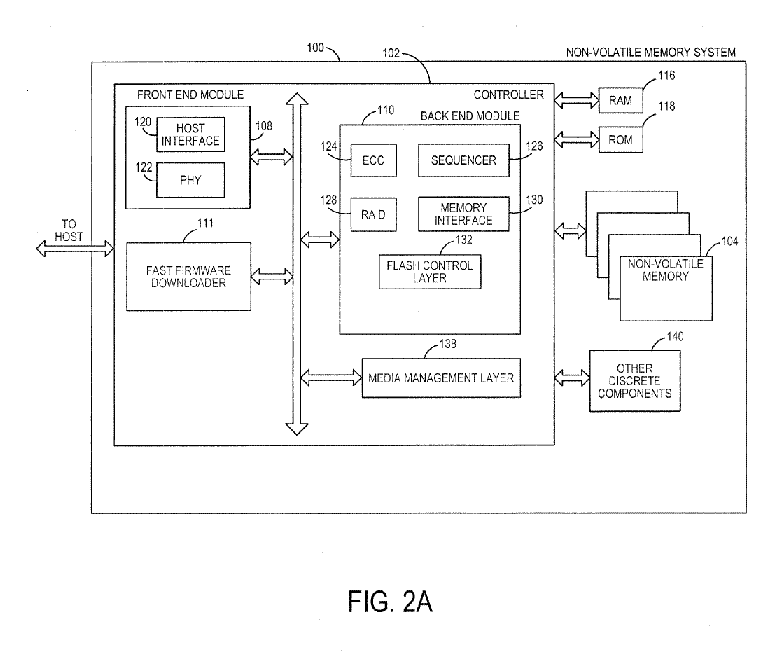

FIG. 2A is a block diagram illustrating exemplary components of controller 102 in more detail, Controller 102 includes a front end module 108 that interfaces with a host, a back end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example. Modules of the controller 102 may include a fast firmware downloader 111 that is configured to activate new firmware stored in volatile memory before storing the new firmware in non-volatile memory. Implementation of the functionality of this module will be discussed in more detail below.

Referring again to modules of the controller 102, a buffer manager/bus controller (not shown) manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, SAS, Fibre Channel, USB, PCIe, and NVMe. The host interface 120 typically facilitates transfer for data, control signals, and timing signals.

Back end module 110 includes an error correction controller (ECC) engine 124 that encodes the data bytes received from the host, and decodes and error corrects the data bytes read from the non-volatile memory. A command sequencer 126 (also known as a flash interface module) generates command sequences, such as program and erase command sequences, and schedules those sequences to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

The memory system 100 also includes other discrete components 140, such as external electrical interfaces, external RAM, resistors, capacitors, or other components that may interface with controller 102. In alternative embodiments, one or more of the physical layer interface 122, RAID module (not shown), media management layer 138 and buffer management/bus controller (not shown) are optional components that are not necessary in the controller 102.

FIG. 2B is a block diagram illustrating exemplary components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two dimensional and/or three dimensional configuration. Non-volatile memory die 104 further includes a data cache 156 that caches data.

Peripheral circuitry 141 includes a state machine 152 that provides status information to controller 102. The circuitry 141 can provide additional functionality, which will be described in more detail below. In general, “circuitry” can include one or more components and be a pure hardware implementation and/or a combined hardware/software (or firmware) implementation. Accordingly, “circuitry” can take the form of one or more of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example.

As mentioned above, prior memory systems use a process to download new firmware that can be slow and lead to non-working or unreliable firmware being used by the system. The following embodiments describe a memory system and method for fast firmware download that overcomes these problems. While some of these examples will be discussed in terms of embedded systems and specific components (e.g., memory and chip types), it should be understood that these embodiments can also be used with non-embedded systems and other components.

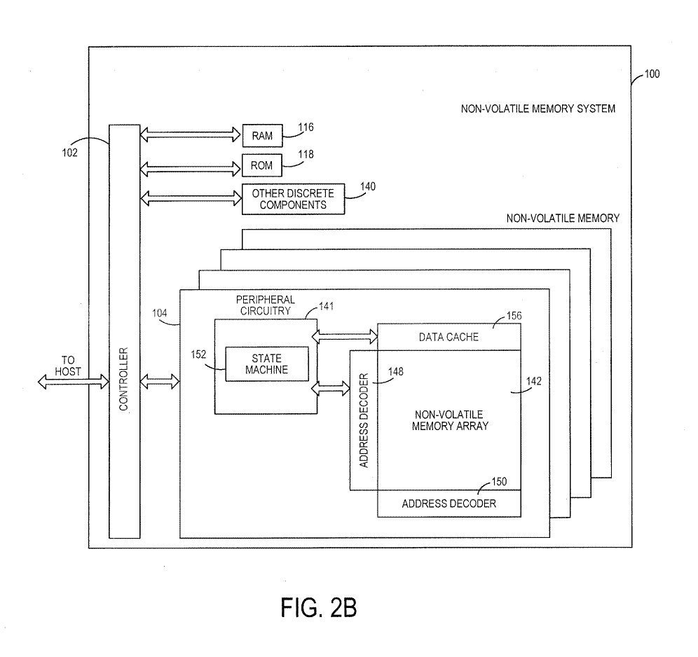

Returning to the drawings, FIG. 3 is an illustration of a memory system 300 of an embodiment. As shown in FIG. 3, in this embodiment, the memory system 300 comprises a controller (here, a system-on-chip) 310 with an internal volatile memory (here, IRAM) 315, a volatile memory (here, DRAM) 320 that is external to the controller 310, first non-volatile memory (here NOR Flash) 330, a power fail backup system 340, and a second non-volatile memory 350. This memory system 300 can be an implementation of the memory system 100 shown in FIG. 2A.

FIG. 3 shows the memory system 300 in communication with a download server 360 via an external interface 370 (e.g., SATA, SAS, PCIe). As noted above, the memory system 300 can be embedded in a device, such as a solid-state drive or mobile phone, in which case, other components (not shown) can be in the communication channel between the memory system 300 and the download server 360.

As explained in the background section, prior memory systems would store a new firmware image in non-volatile memory, using the volatile memory as a buffer. Because the process of erasing old firmware from and writing the new firmware to the non-volatile memory can take a relatively-long time, the memory system may not be able to process other requests or may operate in a reduced performance during the firmware update process. This can result in the system being unavailable to a user or in the system operating in a slow manner. Also, no check is performed on the new firmware to make sure it will function properly before it replaces the old firmware.

To address these issues, the memory system 300 in this embodiment downloads the full firmware image into volatile memory 320 and skips the process of writing the firmware to non-volatile memory 330 in the context of a download request from the host. The details of where the firmware image is placed in the volatile memory 320 is passed to the boot process for activating new boot loader and firmware. This process will be illustrated in more detail below and in conjunction with the drawings.

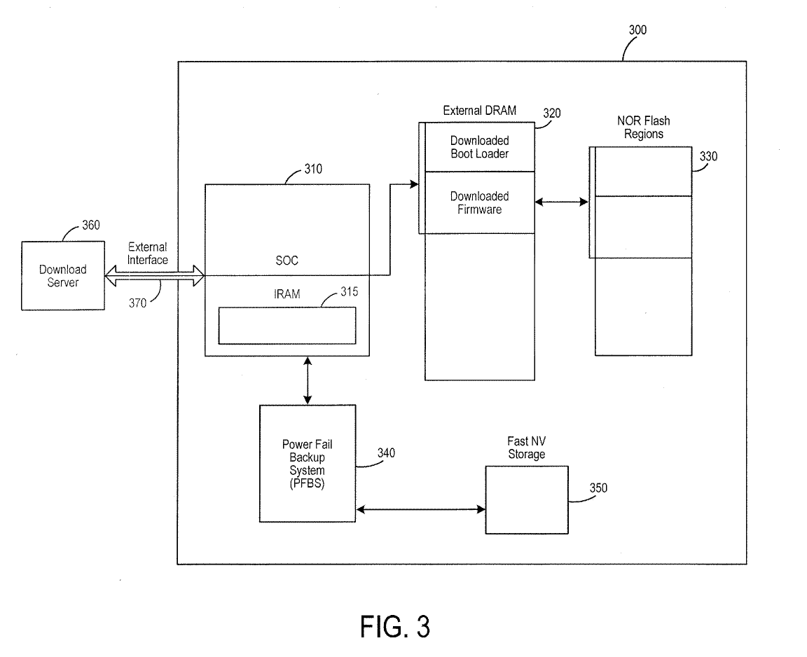

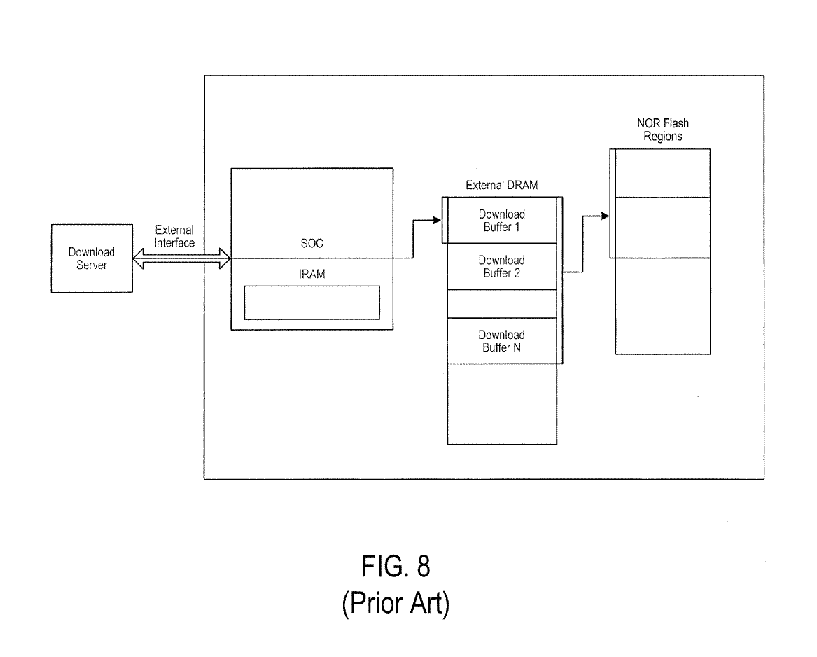

As shown in FIG. 3, in this embodiment, the memory system 300 receives a new boot loader and new firmware from the download server 360 and stores them in the volatile memory 320. (Although not shown in FIG. 3, the existing boot loader and firmware are stored in the non-volatile memory 330 and are read into the volatile memory 320 during boot-up of the memory system 300.) Again, in contrast to the prior memory system shown in FIG. 8, the volatile memory 320 is not used merely to buffer the firmware on its way to the non-volatile memory 330 in the download process. Instead, the controller 310 interacts with the firmware stored in the volatile memory 320 to improve the download process. Specifically, as shown in FIG. 4, in one embodiment, once the firmware is fully downloaded to the volatile memory 320, the controller 310 can copy the new boot loader from the volatile memory 320 to the controller's internal volatile memory 314, and the boot process can be started using the new boot loader.

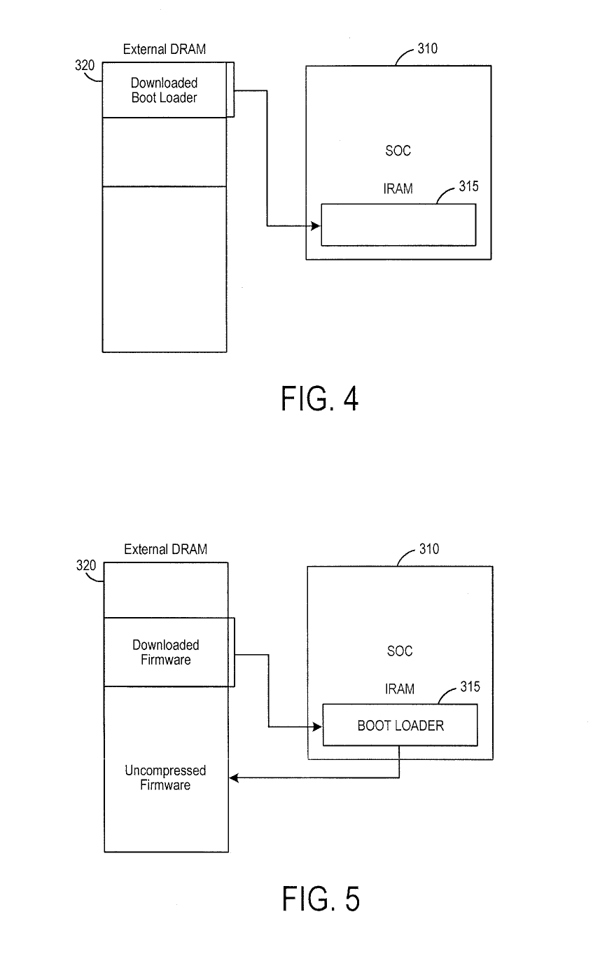

As shown in FIG. 5, the controller 310 then executes the boot loader, which causes the controller 310 to read the firmware from the volatile memory 320. The controller 310 activates the new firmware by decompressing the firmware and storing the decompressed firmware in the volatile memory 320. In this process, the boot loader can save various parameters, such as, but not limited to, the location of the downloaded firmware region in the volatile memory 320 and the boot type (e.g., soft reboot using DRAM, etc.), which will help write the new firmware to non-volatile memory 330. In some embodiments, a reset is used to activate the new firmware. In such embodiments, the volatile memory 320 can be kept in auto-refresh mode to allow for all run time information (like mapping tables in solid-state drives) to be preserved across download. This takes out the need to rebuild run time information, thereby greatly reducing download and initialization time.

So, prior to the new firmware download process, the memory system 100 stores the old boot loader and old firmware in the non-volatile memory 330. During boot-up of the memory system, the controller 310 reads the old boot loader from the non-volatile memory 330 and loads it into the volatile memory 320 (or the controller's volatile memory 315). The old boot loader reads the old firmware from the non-volatile memory 330 and loads it into the volatile memory 320 (or the controller's volatile memory 315). The controller 310 executes the old firmware to boot-up the memory system 300. After the new bootloader and new firmware have been downloaded to the volatile memory 320, the controller reads the new bootloader into the controller's volatile memory 315. The old boot loader instructs the new boot loader as to the location in the volatile memory 320 of the new firmware. The memory system 300 then performs a soft reboot, with the new bootloader reading the new firmware into the controller's volatile memory 315 from the volatile memory 320.

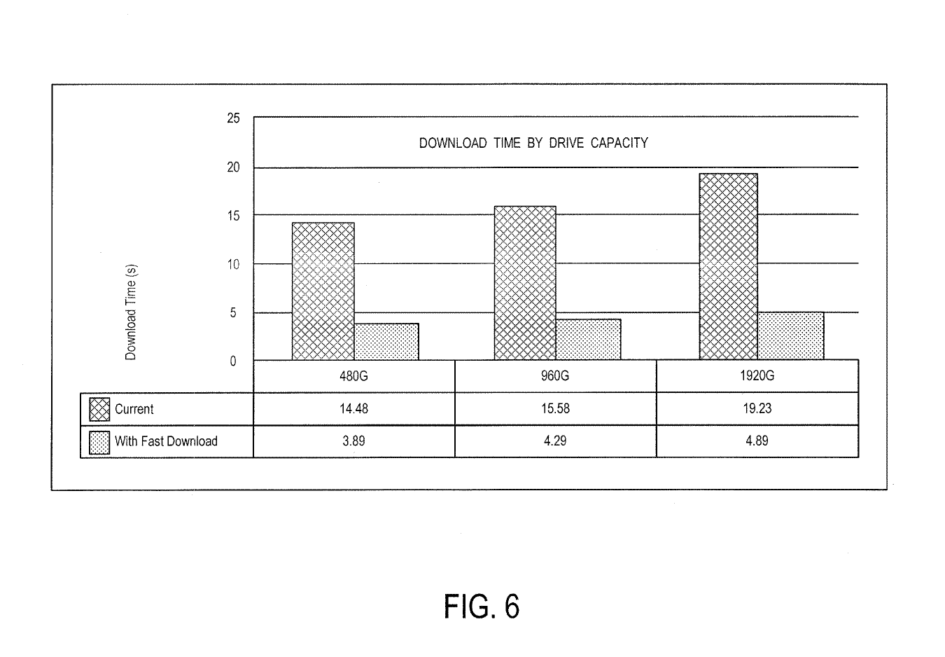

Once the new firmware has successfully booted, the process of saving the compressed firmware from the volatile memory 320 to the non-volatile memory 330 will start. Although the firmware is eventually stored in the non-volatile memory 330, in one embodiment, the firmware is stored in the non-volatile memory 330 only after it is compressed. In one embodiment, the controller 310 is configured to copy the compressed firmware from the volatile memory 320 to the non-volatile memory 330 as a background process once the new firmware image is up and running, with minimal impact to host requests. This reduces the down-time of the memory system 300, as compared to the prior approaches discussed above. The time-savings advantage of this embodiment are illustrated in FIG. 6, which shows exemplary download times of three different solid-state drives by drive capacity. As can be seen in FIG. 6, this embodiment (“with fast download”) provides substantial improvement in firmware download time as compared to the prior approach. In addition to being faster, this embodiment provides a more-reliable firmware download, as the controller 310 can validate the decompressed firmware before copying the firmware from the volatile memory 320 to the non-volatile memory 330. By validating the firmware before writing it to the non-volatile memory 330, the controller 310 can prevent corruption of the non-volatile memory 330 that would otherwise lead to a non-working system.

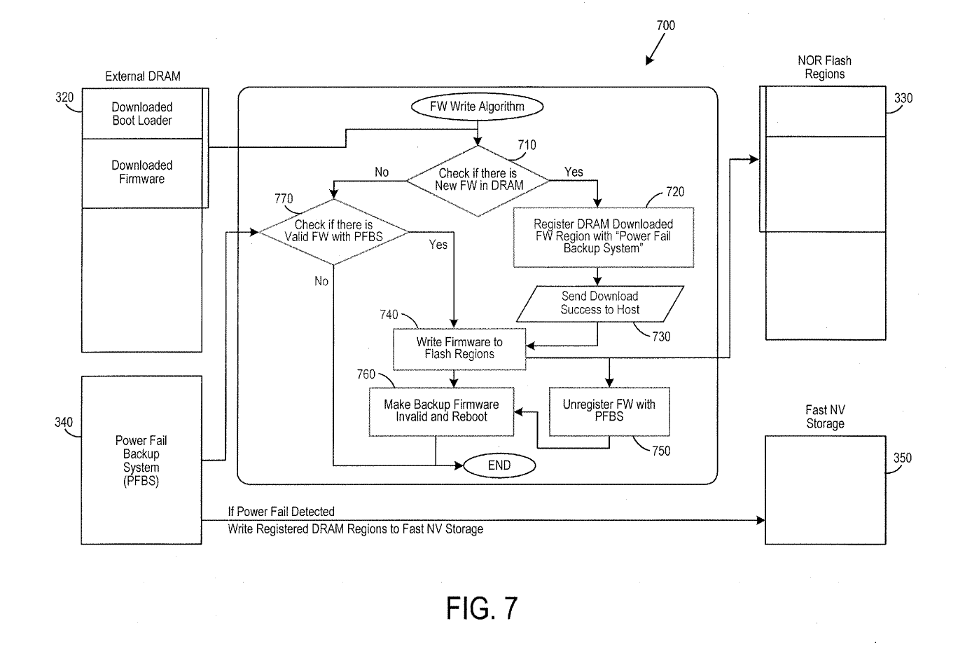

Until the firmware is copied from the volatile memory 320 to the non-volatile memory 330 there is a risk that the firmware can be lost if a power loss to the memory system 300 occurs. FIG. 7 is a flow chart 700 of a method of an embodiment that can be used to protect against this. As shown in FIG. 7, the controller 310 checks to see if there is new firmware in the volatile memory 320 (act 710). The controller 310 can do this, for example, by checking to see if parameters, such as the location of the new firmware in the volatile memory 320 and boot type, are stored in the volatile memory 320. If there is new firmware in the volatile memory 320, the controller 720 registers the region in the volatile memory 320 that contains the firmware with the memory system's power fail backup system 340 (act 720) and sends a download success message to the host as a guarantee that the new firmware will be written to the non-volatile memory 330 (act 730). With the regions registered, if there is a power loss to the memory system 300, the power fail backup system 340 will copy the firmware from the indicated regions in the volatile memory 320 to the second non-volatile memory 350. (In one embodiment, the second non-volatile memory 350 is faster than the first non-volatile memory 330. For example, the second non-volatile memory 350 can have single-level cells (SLC), while the first non-volatile memory 330 can have multi-level cells (MLC).) After power is returned to the memory system 300, the power fail backup system 340 copies the compressed firmware from the second non-volatile memory 350 to the volatile memory 320.

Next, the controller 310 writes the firmware from the volatile memory 320 to the non-volatile memory 330. After the firmware is written to non-volatile memory 330, there is no longer a risk of the firmware being lost if there is a power loss. So, the controller 310 unregisters the firmware from the power fail backup system 340 (act 750). The controller 310 then makes the old, backup firmware invalid and reboots the system (act 760). With the new firmware up and running, the controller 310 will be able to process new incoming requests from the host.

Going back to decision 710, if there is no new firmware in the volatile memory 320, the controller 310 checks to see if there is valid firmware registered in the power fail backup system 340 (act 770). If there is, acts 740-760 are carried out, as above.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A memory system comprising:
non-volatile memory;
volatile memory; and
a controller in communication with the non-volatile memory and the volatile memory, wherein the controller is configured to:
receive a boot loader and compressed firmware;
store the boot loader and compressed firmware in the volatile memory;
execute the boot loader, wherein executing the boot loader causes the controller to read the compressed firmware from the volatile memory, decompress the compressed firmware, and store the decompressed firmware in the volatile memory; and
copy the compressed firmware from the volatile memory to the non-volatile memory.

2. The memory system of claim 1, wherein the controller is further configured to copy the compressed firmware from the volatile memory to the non-volatile memory as a background process.

3. The memory system of claim 1, wherein the controller is further configured to validate the decompressed firmware before copying the compressed firmware from the volatile memory to the non-volatile memory.

4. The memory system of claim 1, wherein the controller is further configured to reset the memory system to activate the firmware.

5. The memory system of claim 4, wherein the controller is further configured to keep the volatile memory in an auto-refresh mode during the reset to activate the firmware.

6. The memory system of claim 1 further comprising:
a power fail backup system in communication with the controller; and
a second non-volatile memory in communication with the power fail backup system;
wherein the controller is further configured to register, in the power fail backup system, an identification of a location in the volatile memory of the decompressed firmware after storing the decompressed firmware in the volatile memory but before copying the compressed firmware to the non-volatile memory; and
wherein the power fail backup system is configured to:
copy the compressed firmware from the volatile memory to the second non-volatile memory in response to a power loss to the memory system; and
copy the compressed firmware from the second non-volatile memory to the volatile memory after power is returned.

7. The memory system of claim 6, wherein the second non-volatile memory is configured to be written to faster than the non-volatile memory.

8. The memory system of claim 6, wherein the controller is further configured to unregister, in the power fail backup system, the identification of the location in the volatile memory of the decompressed firmware after the compressed firmware is copied from the volatile memory to the non-volatile memory.

9. The memory system of claim 1, wherein the firmware is an update to a prior version of the firmware stored in the memory system, and wherein the controller is further configured to invalidate the prior version after the compressed firmware is copied from the volatile memory to the non-volatile memory.

10. The memory system of claim 1, wherein the controller is part of a system-on-chip.

11. The memory system of claim 10, wherein the system-on-chip comprises its own volatile memory, and wherein the controller is further configured to copy the boot loader from the volatile memory to the system-on-chip's volatile memory before executing the boot loader.

12. The memory system of claim 1, wherein the non-volatile memory comprises a three-dimensional memory array.

13. The memory system of claim 1, wherein the memory system is embedded in a host.

14. The memory system of claim 1, wherein the memory system is removably connectable to a host.

15. A method for fast firmware download, the method comprising:
performing the following in a memory system comprising non-volatile memory and volatile memory:
receiving new firmware;
storing the new firmware in the volatile memory; and
activating the new firmware before storing it in the non-volatile memory.

16. The method of claim 15, wherein activating the new firmware comprises decompressing the new firmware.

17. The method of claim 15, wherein the new firmware is stored in the non-volatile memory as a background process.

18. The method of claim 15 further comprising validating the new firmware before storing it in the non-volatile memory.

19. The method of claim 15 further comprising registering the new firmware in a power fail backup system prior to storing the new firmware in the non-volatile memory.

20. The method of claim 15, wherein the non-volatile memory comprises a three-dimensional memory array.

21. The method of claim 15, wherein the memory system is embedded in a host.

22. The method of claim 15, wherein the memory system is removably connectable to a host.

23. A memory system comprising:
non-volatile memory;
volatile memory; and
a fast firmware downloader in communication with the non-volatile memory and the volatile memory, wherein the fast firmware downloader is configured to activate new firmware stored in the volatile memory before storing the new firmware in the non-volatile memory.

24. The memory system of claim 23, wherein the non-volatile memory comprises a three-dimensional memory array.

25. The memory system of claim 23, wherein the memory system is embedded in a host.

26. The memory system of claim 23, wherein the memory system is removably connectable to a host.
